(19) United States
(12) Patent Application Publication
(10) Pub. No.: US 2006/0094621 A1
(43) Pub. Date: May 4, 2006

(54) Process for improving processability of a concentrate and compositions made by the same

(76) Inventors: Glenn Thomas Jordan IV, Indian Springs, OH (US); Stacie Ellen Hecht, West Cheter, OH (US); Kenneth Nathan Price, Wyoming, OH (US); Patricia Sara Berger, Cincinnati, OH (US); Yousef Georges Aouad, Cincinnati, OH (US); Jean Wevers, Steenhuffel (BE); Dennis Allen Beckholt, Fairfield, OH (US); Frank William Denome, Cincinnati, OH (US); Kevin George Goodall, Tervuren (BE); Jose Luis Vega, Cincinnati, OH (US); Michael Stanford Showell, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/263,390

(22) Filed: Oct. 31, 2005

Related U.S. Application Data
(60) Provisional application No. 60/624,052, filed on Nov. 1, 2004.
(60) Provisional application No. 60/624,128, filed on Nov. 1, 2004.

(51) Int. Cl. C11D 10/02

(52) U.S. Cl. 510/286

(57) ABSTRACT

Methods for improving the processability of an active concentrate are disclosed. Specifically, an ionic liquid is incorporated into the diluting process to lower the viscosity and avoid the formation of a viscosity-increasing gel phase. Moreover, the ionic liquid may comprise an ion active capable of delivering a desired benefit, which accompanies and/or enhances the benefit provided by the active in the concentrate. The present invention also encompasses a dilution process for forming a product composition from a conventional active concentrate or an ionic liquid containing composition. The present invention further comprises compositions made by these processes.

### CROSS REFERENCE TO RELATED APPLICATIONS

This application claims priority under 35 U.S.C. §119(e) from Provisional Application Ser. Nos. 60/624,052 and 60/624,128, both of which were filed on Nov. 1, 2004.

### FIELD OF THE INVENTION

The present invention is directed to a method for improving the processability of an active concentrate. Specifically, an ionic liquid is incorporated into the diluting process to lower the viscosity and avoid the formation of a viscosity-increasing gel phase. Moreover, the ionic liquid may comprise an ion active capable of delivering a desired benefit, which accompanies and/or enhances the benefit provided by the active in the concentrate. The present invention also encompasses a dilution process for forming a product composition from a conventional active concentrate or an ionic liquid containing composition. The present invention further comprises compositions made by these processes.

### BACKGROUND OF THE INVENTION

Generally speaking, ionic liquids refer to a specific class of molten salts which are liquid at temperatures of 100° C. or below. Ionic liquids have very low vapor pressure and generate virtually no hazardous vapors. Due to the charged species comprising the ionic fluids, they provide a highly polar medium.

In recent years, there is much interest in this class of novel materials. Ionic liquids have been extensively evaluated as environmental-friendly or “green” alternatives to conventional organic solvents for a broad range of organic synthetic applications. In addition, ionic liquids have also been used in organic synthesis applications as catalysts. Furthermore, ionic liquids have also been found useful in chemical separation and extraction and electrochemistry, for example, in fuel cells, electrodeposition processes and other electrochemical applications. Conventional ionic liquids for a wide range of chemical processes are described in “Ionic Liquid” by J. D. Holbrey and K. R. Seddon, and in Clean Products and Processes, Vol. 1, pp. 223-236 (1999). Other examples of ionic liquids are described in U.S. patents: U.S. Pat. No. 6,048,388; U.S. Pat. No. 5,827,602; U.S. Patent Publications: U.S. 2003/915735A1; U.S. 2004/0007693A1; U.S. 2004/0035293A1; and PCT publications: WO 02/26701; WO 03/074494; WO 03/022812; WO 04/016570.

Additionally, ionic liquids have been shown to be effective in applications where water-based chemistry can be problematic (for example, applications involving proton transfer or nucleophilicity), or in applications where certain coordination chemistry could have a damaging effect on the substrates involved.

Moreover, ionic liquids have found applications in consumer product formulations and industrial product formulations for surface treating, air treating, cleaning and other benefits, as described in U.S. 2004/0077519A1.

Some benefit agents or active materials used in such consumer products are substantially water insoluble. In some cases, these active materials are supplied by the manufacturers in a concentrated form, sometimes up to 70-90 weight % of the concentrate is the active material. In other cases, these active materials are substantially water soluble, the concentrates may use organic solvents, such as isopropanol or ethanol, and sometimes a minor amount (up to 10%) of water and/or surfactants may be used. The active concentrates are then diluted or dispersed in the process of making consumer products which are distributed to the retailers and/or consumers. Dispersibility and viscosity characteristics of these active concentrates can pose severe problems for the processors.

In addition, these active materials are prepared in the form of dispersions in the aqueous-based products. It is generally not possible to prepare such aqueous dispersions with more than about 10% of the active materials without encountering intractable problems of product viscosity and storage stability. Such problems are manifested in phase separated and/or non-pourable products, inadequate dispersion and/or dissolving characteristics under normal use condition by consumers.

It is desirable to take advantage of the various unique characteristics of the ionic liquid to address these problems.

### SUMMARY OF THE INVENTION

One aspect of the present invention relates to a method of improving the processability of an active concentrate in the preparation of consumer products. The process for preparing a product composition comprises: a) providing a concentrate containing a benefit agent capable of delivering a fabric treating benefit, a surface treating benefit and/or an air treating benefit; b) mixing the concentrate with mixing the concentrate with an ionic liquid and optionally, a diluent, an adjunct, or combinations thereof, thereby forming the product composition; wherein the resulting product composition has a viscosity of less than about 5000 mPa·s at room temperature or less than about 2000 mPa·s at a temperature ranging from about 40° C. to about 60° C. In addition, the composition does not exhibit a gel phase throughout the process.

Another aspect of the present invention relates to an advantageous process for preparing a consumer product formulation from a composition containing ionic liquid actives of the present invention. The process comprises a) providing a composition comprising a first ionic liquid composed of an ion active and an ionic liquid-forming counter ion, the ion active is capable of delivering a fabric treating benefit, a surface treating benefit, and/or an air treating benefit; and b) diluting the composition by addition of water, organic solvent, and/or a second ionic liquid, wherein the composition does not exhibit a gel phase throughout the process.

The present invention also encompasses the product composition prepared by these processes.

Additional embodiments of the compositions and processes are described in further detail in the following detailed description.

### DETAILED DESCRIPTION OF THE INVENTION

As used herein, the term “active” means a material capable of delivering benefits, for example, a fabric treating benefit, a surface treating benefit, and/or an air treating benefit, to a target substrate. As used herein, the terms “active” and “benefit agent” are interchangeable.

As used herein, the term “ion active” means the ion (cationic or anionic) form of an active or a benefit agent; the ion active retains the active's capability of delivering benefits to a target substrate.

The compositions according to the present invention comprise an ionic liquid active composed of an ion active and an ionic liquid-forming counter ion. The ion active which forms the ionic liquid active is any ionic moiety which provides the desired treating benefit to a target object or a target surface. Within the present context, fabric treating refers generally to the cleaning, refreshing and/or care of any textile material or product, including, but not limited to, loose or free fibers, yarns (including threads), woven textiles, nonwoven textiles, knitted textiles, articles, and the like. Fabric articles include, but are not limited to, garments, components used in the manufacture of garments, carpets, upholstery, and the like. Additionally, such fabrics may be formed of any natural, man-made or synthetic material, or a combination thereof. Surface treating refers generally to the cleaning, refreshing and/or care of any non-fabric solid surface material, including, but not limited to, dishes, utensils and other items intended for food contact, and hard surfaces, for example, floors, counters, appliances, sinks, tubs, toilets, tiles and the like. Air treating refers to cleaning, refreshing and/or care, including improvement, of environmental air, typically in an enclosed area. The target surface also includes biological surfaces, including but are not limited to skin, hair and teeth.

Examples of suitable ion actives include, but are not limited to, the ion form of surfactants, bleaches, bleach activators, polymeric builders (e.g., polyacrylates, poly(acrylic-maeic) copolymers), antimicrobial agents, fabric softeners, dyes, dye fixatives, optical brighteners, or combinations thereof.

The ionic active may be anionic or cationic, as necessary for the desired benefit, and is typically derived from a salt or acid of a known benefit agent. For example, if a conventional benefit agent in salt form is of the formula X⁺Y⁻ and the anion Y⁻ provides the desired fabric, surface or air treating activity, then the anionic form of the benefit agent is employed in the ionic liquid active. Examples of suitable anionic actives include, but are not limited to, anionic phosphate builders, anionic linear alkyl sulfate and sulfonate detersive surfactants, anionic alkylated and alkoxylated sulfate and sulfonate detersive surfactants, anionic perborate, percarbonate and peracid bleaches, and the like. Alternatively, if the cation X⁺ of the conventional benefit agent in the salt form of the formula X⁺Y⁻ provides the desired fabric, surface or air treating activity, then the cationic form of the benefit agent is employed in the ionic liquid active. Examples of suitable cationic actives include, but are not limited to, cationic quaternary ammonium antimicrobial agents, cationic quaternary ammonium fabric softeners, cationic quaternary ammonium surfactants, and the like. Examples of suitable zwitterionic actives include, but are not limited to, amine oxide surfactants and betaine surfactants.

Additionally, a conventional nonionic or zwitterionic benefit agent can be converted to an ionic active by ionic functionalization with a cationic functional group (such as a trimethyl ammonium alkyl group) or an anionic functional group (such as a sulfate group). Alternatively, a zwitterinoic benefit agent can be ionized by pH changes to the compositions to below the pKa of the zwitterionic active, resulting in a cationic form of the benefit agent.

Furthermore, the anionic form of an benefit agent can be combines with a cationic form of another benefit agent, for example, the ionic liquid actives may compose of pairings of a cationic fabric softener, a cationic antimicrobial, a cationic surfactant with an anionic bleach activator or an anionic surfactant.

In some embodiments, the ionic active is formed from known benefit agents which are insoluble or exhibit low solubility when employed in conventional fabric, surface or air treating compositions. The ion active, upon fictionalization or ionization, will be combined with selected ionic liquid-forming counter ions to form the salt having ionic liquid characteristics, such as low melting point and/or flowability as described below.

Ionic liquid as used herein refers to a salt that has a melting temperature of about 100° C. or less, or, in an alternative embodiment, has a melting temperature of about 60° C. or less, or, in yet another alternative embodiment, has a melting temperature of about 40° C. or less. In other embodiments, the ionic liquids exhibit no discernible melting point (based on DSC analysis) but are “flowable” at a temperature of about 100° C. or below, or, in another embodiment, are “flowable” at a temperature of from about 20 to about 80° C., i.e., the typical fabric or dish washing temperatures. As used herein, the term “flowable” means that the ionic liquid exhibits a viscosity of less than about 10,000 mPa·s at the temperatures as specified above. It should be understood that the terms “ionic liquid”, “ionic liquids”, and “IL” refer to ionic liquids, ionic liquid composites, and mixtures (or cocktails) of ionic liquids.

It should be understood that the terms “ionic liquid”, “ionic compound”, and “IL” refer to ionic liquids, ionic liquid composites, and mixtures (or cocktails) of ionic liquids. The ionic liquid can comprise an anionic IL component and a cationic IL component. When the ionic liquid is in its liquid form, these components may freely associate with one another (i.e., in a scramble). As used herein, the term “cocktail of ionic liquids” refers to a mixture of two or more, preferably at least three, different and charged IL components, wherein at least one IL component is cationic and at least one IL component is anionic. Thus, the pairing of three cationic and anionic IL components in a cocktail would result in at least two different ionic liquids. The cocktails of ionic liquids may be prepared either by mixing individual ionic liquids having different IL components, or by preparing them via combinatorial chemistry. Such combinations and their preparation are discussed in further detail in U.S. 2004/0077519A1 and U.S. 2004/0097755A1. As used herein, the term “ionic liquid composite” refers to a mixture of a salt (which can be solid at room temperature) with a proton donor Z (which can be a liquid or a solid) as described in the references immediately above. Upon mixing, these components turn into a liquid at about 100° C. or less, and the mixture behaves like an ionic liquid.

Nonlimiting examples of anions and cations suitable for use in the ionic liquids for the present invention are discussed in further detail.

Anions

Anions suitable for use in the ionic liquids of the present invention include, but are not limited to, the following materials:
(1) Alkyl sulfates (AS), alkoxy sulfates and alkyl alkoxy sulfates, wherein the alkyl or alkoxy is linear, branched or mixtures thereof; furthermore, the attachment of the sulfate group to the alkyl chain can be terminal on the alkyl chain (AS), internal on the alkyl chain (SAS) or mixtures thereof: non-limiting examples include linear C₁₀-C₂₀ alkyl sulfates having formula:
   CH₃(CH₂)_{x+y}CH₂OSO₃⁻M⁺
wherein x+y is an integer of at least 8, preferably at least about 10; M⁺ is a cation selected from the cations of the ionic liquids as described in detail herein; or linear C₁₀-C₂₀ secondary alkyl sulfates having formula: 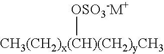
wherein x+y is an integer of at least 7, preferably at least about 9; x or y can be 0, M⁺ is a cation selected from the cations of the ionic liquids as described in detail herein; or C10-C20 secondary alkyl ethoxy sulfates having formula: 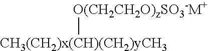
wherein x+y is an integer of at least 7, preferably at least about 9; x or y can be 0, M⁺ is a cation selected from the cations of the ionic liquids as described in detail herein; non-limiting examples of alkoxy sulfate include sulfated derivatives of commercially available alkoxy copolymers, such as Pluronics® (from BASF);
(2) Mono- and di-esters of sulfosuccinates: non-limiting examples include saturated and unsaturated C₁₂₋₁₈ monoester sulfosuccinates, such as lauryl sulfosuccinate available as Mackanate LO-100® (from The McIntyre Group); saturated and unsaturated C₆-C₁₂ diester sulfosuccinates, such as dioctyl ester sulfosuccinate available as Aerosol OT® (from Cytec Industries, Inc.);
(3) Methyl ester sulfonates (MES);
(4) Alkyl aryl sulfonates, non-limiting examples include tosylate, alkyl aryl sulfonates having linear or branched, saturated or unsaturated C₈-C₁₄ alkyls; alkyl benzene sulfonates (LAS) such as C₁₁-C₁₈ alkyl benzene sulfonates; and sulfonates of benzene;
(5) Alkyl glycerol ether sulfonates having 8 to 22 carbon atoms in the alkyl moiety;
(6) Diphenyl ether (bis-phenyl) derivatives: Non-limiting examples include triclosan (2,4,4′-trichloro-2′-hydroxydiphenyl ether) and diclosan (4,4′-dichloro-2-hydroxydiphenyl ether), both are available as Irgasan® from Ciba Specialty Chemicals;
(7) Linear or cyclic carboxylates: non-limiting examples include citrate, lactate, tartarate, succinate, alkylene succinate, maleate, gluconate, formate, cinnamate, benzoate, acetate, salicylate, phthalate, aspartate, adipate, acetyl salicylate, 3-methyl salicylate, 4-hydroxy isophthalate, dihydroxyfumarate, 1,2,4-benzene tricarboxylate, pentanoate and mixtures thereof;
(8) Mid-chain branched alkyl sulfates (HSAS), mid-chain branched alkyl aryl sulfonates (MLAS) and mid-chain branched alkyl polyoxyalkylene sulfates; non-limiting examples of MLAS are disclosed in U.S. Pat. No. 6,596,680; U.S. Pat. No. 6,593,285; and U.S. Pat. No. 6,202,303;
(9) Sarcosinates having the general formula RCON(CH₃)CH₂CO₂⁻, wherein R is an alkyl from about C₈₋₂₀; non-limiting examples include ammonium lauroyl sarcosinate, available as Hamposyl AL-30® from Dow Chemicals and sodium oleoyl sarcosinate, available as Hamposyl O® from Dow Chemical;
(10) Sulfated and sulfonated oils and fatty acids, linear or branched, such as those sulfates or sulfonates derived from potassium coconut oil soap available as Norfox 1101® from Norman, Fox & Co. and Potassium oleate from Chemron Corp.;
(11) Fatty acid ester sulfonates having the formula:
   R¹—CH(SO₃⁻)CO₂R²
wherein R¹ is linear or branched C₈ to C₁₈ alkyl, and R² is linear or branched C₁ to C₆ alkyl;
(12) Sweetener derived anions: saccharinate and acesulfamate; 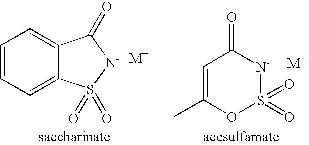
wherein M+ is a cation selected from the cations of the ionic liquids as described herein;
(13) Ethoxylated amide sulfates; sodium tripolyphosphate (STPP); dihydrogen phosphate; fluroalkyl sulfonate; bis-(alkylsulfonyl) amine; bis-(fluoroalkylsulfonyl)amide; (fluroalkylsulfonyl)(fluoroalkylcarbonyl)amide; bis(arylsulfonyl)amide; carbonate; tetrafluorborate (BF₄⁻); hexaflurophosphate (PF₆⁻);
(14) Anionic bleach activators having the general formula:
   R¹—CO—O—C₆H₄—R²
wherein R¹ is C₈-C₁₈ alkyl, C₈-C₁₈ amino alkyl, or mixtures thereof, and R² is sulfonate or carbonate; non-limiting examples such as: 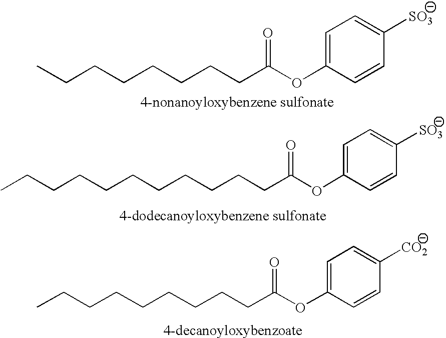
are disclosed in U.S. Pat. No. 5,891,838; U.S. Pat. No. 6,448,430; U.S. Pat. No. 5,891,838; U.S. Pat. No. 6,159,919; U.S. Pat. No. 6,448,430; U.S. Pat. No. 5,843,879; U.S. Pat. No. 6,548,467.
   Cations

Cations suitable for use in the ionic liquids of the present invention include, but are not limited to, the following materials:
(a) Cations (i.e., in the protonated, cationic form) of amine oxides, phosphine oxides, or sulfoxides: non-limiting examples include amine oxide cations containing one C₈₋₁₈ alkyl moiety and 2 moieties selected from the group consisting of C₁₋₃ alkyl groups and C₁₋₃ hydroxyalkyl groups; phosphine oxide cations containing one C₁₀₋₁₈ alkyl moiety and 2 moieties selected from the group consisting of C₁₋₃ alkyl groups and C₁₋₃ hydroxyalkyl groups; and sulfoxide cations containing one C₁₀₋₁₈ alkyl moiety and a moiety selected from the group consisting of C₁₋₃ alkyl and C₁₋₃ hydroxyalkyl moieties; in some embodiments, the amine oxide cations have the following formula: 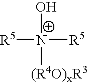
wherein R³ is an C₈₋₂₂ alkyl, C₈₋₂₂ hydroxyalkyl, C₈₋₂₂ alkyl phenyl group, and mixtures thereof; R⁴ is an C₂₋₃ alkylene or C₂₋₃ hydroxyalkylene group or mixtures thereof; x is from 0 to about 3; and each R⁵ is independently an C₁₋₃ alkyl or C₁₋₃ hydroxyalkyl group or a polyethylene oxide group containing an average of from about 1 to about 3 ethylene oxide groups; the R⁵ groups may be attached to each other, e.g., through an oxygen or nitrogen atom, to form a ring structure; other exemplary amine oxide cations include C₁₀-C₁₈, C₁₀, C₁₀-C₁₂, and C₁₂-C₁₄ alkyl dimethyl amine oxide cations, and C₈-C₁₂ alkoxy ethyl dihydroxy ethyl amine oxide cations;
(b) Betaines having the general formula:
   R—N⁽⁺⁾(R¹)₂—R²COOH
wherein R is selected from the group consisting of alkyl groups containing from about 10 to about 22 carbon atoms, preferably from about 12 to about 18 carbon atoms, alkyl aryl and aryl alkyl groups containing a similar number of carbon atoms with a benzene ring treated as equivalent to about 2 carbon atoms, and similar structures interrupted by amido or ether linkages; each R¹ is an alkyl group containing from 1 to about 3 carbon atoms; and R² is an alkylene group containing from 1 to about 6 carbon atoms; non-limiting examples of betaines include dodecyl dimethyl betaine, acetyl dimethyl betaine, dodecyl amidopropyl dimethyl betaine, tetradecyl dimethyl betaine, tetradecyl amidopropyl dimethyl betaine, dodecyl dimethyl ammonium hexanoate; and amidoalkylbetaines which are disclosed in U.S. Pat. Nos. 3,950,417; 4,137,191; and 4,375,421; and British Patent GB No. 2,103,236; in another embodiment, the cation may be a sulfobetaine, which are disclosed in U.S. Pat. No. 4,687,602;
(c) Diester quaternary ammonium (DEQA) cations of the type:
   R₍₄₋ₘ₎—N⁺—[(CH₂)ₙ—Y—R¹]ₘ
wherein each R substituent is selected from hydrogen; C₁-C₆ alkyl or hydroxyalkyl, preferably methyl. ethyl, propyl, or hydroxyethyl, and more preferably methyl; poly(C₁-C₃ alkoxy), preferably polyethoxy; benzyl; or a mixture thereof; m is 2 or 3; each n is from 1 to about 4; each Y is —O—(O)C—, —C(O)—O—, —NR—C(O)—, or —C(O)—NR—; with the proviso that when Y is —O—(O)C— or —NR—C(O)—, the sum of carbons in each R¹ plus one is C₁₂-C₂₂, preferably C₁₄-C₂₀, with each R¹ being a hydrocarbyl, or substituted hydrocarbyl group; in one embodiment, the DEQA cation is an alkyl dimethyl hydroxyethyl quaternary ammonium as discussed in U.S. Pat. No. 6,004,922; in another embodiment, the DEQA cation has the general formula:
   R₃N⁺CH₂CH(YR¹)(CH₂YR¹)
wherein each Y, R, R¹ have the same meanings as before; in yet another embodiment, the DEQA cation is [CH₃]₃ N⁽⁺⁾[CH₂CH(CH₂O(O)CR¹)O(O)CR¹] wherein each R¹ is in the range of C₁₅ to C₁₉;
(d) Alkylene quaternary ammonium cations having the formula:
   R₍₄₋ₘ₎—N⁺—Rₘ¹
wherein each m is 2 or 3; each R is independently an alkyl or hydroxyalkyl C₁-C₆ moiety, preferably methyl, ethyl, propyl or hydroxyethyl, and more preferably methyl; each R¹ is independently a linear or branched, saturated or unsaturated C₆-C₂₂ alkyl or alkoxy moiety, preferably C₁₄-C₂₀ moiety, but no more than one R¹ being less than about C₁₂ and then the other R¹ is at least about C₁₆; or hydrocarbyl or substituted hydrocarbyl moiety, preferably C₁₀-C₂₀ alkyl or alkenyl, most preferably C₁₂-C₁₈ alkyl or alkenyl; in one embodiment, the cation is dialkylenedimethyl ammonium, such as dioleyldimethyl ammonium available from Witco Corporation under the tradename Adogen® 472; in another embodiment, the cation monoalkenyltrimethyl ammonium, such as monooleyltrimethyl ammonium, monocanolatrimethyl ammonium, and soyatrimethyl ammonium;
(e) Difatty amido quaternary ammonium cations such as:
   [R¹—C(O)—NR—R²—N(R)₂—R³—NR—C(O)—R¹]⁺
wherein R and R¹ are as defined in cation (e) above, R² and R³ are C₁-C₆ alkylene moieties; for example, difatty amido quats are commercially available from Witco under the Varisoft® tradename;
(f) C₈₋₂₂ quaternary surfactants such as isostearyl ethyl imidonium available in its ethosulfate salt form as Schercoquat IIS® from Scher Chemicals, Inc., quaternium-52 obtainable as Dehyquart SP® from Cognis Corporation, and dicoco dimethyl ammonium available in its chloride salt form as Arquad 2C-75® from Akzo Nobel Surface Chemistry LLC;
   (g) Cationic esters such as discussed in U.S. Pat. No. 4,228,042, U.S. Pat. No. 4,239,660, U.S. Pat. No. 4,260,529 and U.S. Pat. No. 6,022,844;
(h) 4,5-dichloro-2-n-octyl-3-isothiazolone, which is obtainable as Kathon® from Rohm and Haas;
(i) Quaternary amino polyoxyalkylene derivatives (choline and choline derivatives);
(j) Alkyl oxyalkylene cations;
   (k) Alkoxylate quaternary ammoniums (AQA) as discussed in U.S. Pat. No. 6,136,769;
(l) Substituted and unsubstituted pyrrolidinium, imidazolium, benzimidazolium, pyrazolium, benzpyrazolium, thiazolium, benzthiazolium, oxazolium, benzoxazolium, isoxazolium, isothiazolium, imdazolidenium, Guanidinium, indazolium, quinuclidinium, triazolium, isoquinuclidinium, piperidinium, morpholinium, pyridazinium, pyrazinium, triazinium, azepinium, diazepinium, pyridinium, piperidonium, pyrimidinium, thiophenium; phosphonium; in one embodiment, the cation is an substituted imidazolium cation having the formula: 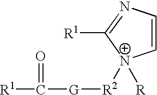
wherein each R and R¹ are as defined in cation (e) above; each R² is a C₁-C₆ alkylene group, preferably an ethylene group; and G is an oxygen atom or an —NR— group; for example, the cation 1-methyl-1-oleylamidoethyl-2-oleylimidazolinium is available commercially from the Witco Corporation under the trade name Varisoft® 3690; in another embodiment, the cation is alkylpyridinium cation having the formula: 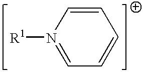
wherein R¹ is an acyclic aliphatic C₈-C₂₂ hydrocarbon group; in another embodiment, the cation is an alkanamide alkylene pyridinium cation having the formula: 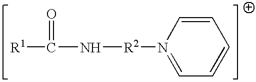
wherein R¹ is a linear or branched, saturated or unsaturated C₆-C₂₂ alkyl or alkoxy moiety, or a hydrocarbyl or substituted hydrocarbyl moiety, and R² is a C₁-C₆ alkylene moiety;
(m) Cationic bleach activators having a quaternary ammonium moiety including but not limited to 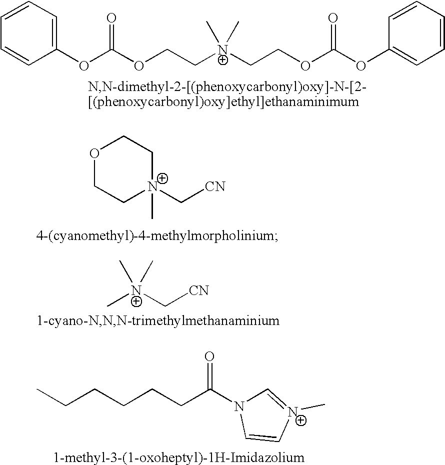
these and other cationic bleach activators suitable for use herein as cations of the ionic liquids are disclosed in U.S. Pat. No. 5,599,781, U.S. Pat. No. 5,686,015, U.S. Pat. No. 5,686,015, WO 95/29160, U.S. Pat. No. 5,599,781, U.S. Pat. No. 5,534,179, EP 1 253 190 A1, U.S. Pat. No. 6,183,665, U.S. Pat. No. 5,106,528, U.S. Pat. No. 5,281,361, and Bulletin de la Societe Chimique de France (1973), (3)(Pt. 2), 1021-7;
(n) Cationic anti-microbial agents, such as cetyl pyridinium, chlorohexidine and domiphen;
(o) Alkylated caffeine cations, such as 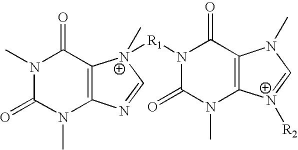
wherein R₁ and R₂ are C1 to C12 alkyl or alkylene groups.

Thus, the ionic liquids suitable for use herein may have various anionic and cationic combinations. The ionic species can be adjusted and mixed such that properties of the ionic liquids can be customized for specific applications, so as to provide the desired solvating properties, viscosity, melting point, and other properties, as desired. These customized ionic liquids have been referred to as “designer solvents”.

In one embodiment, the ionic liquid may be a composite which comprises a mixture of a salt (which can be solid at room temperature) with a proton donor Z (which can be a liquid or a solid) as described above. Upon mixing, these components turn into a liquid at about 100° C. or less, and the mixture behaves like an ionic liquid. Ionic liquid composites comprising various salts and proton donors are disclosed in WO 02/26701 and U.S. 2004/0077519A1.

In some embodiments, ionic liquids (undiluted with adjuncts, co-solvents or free water) employed herein have viscosities of less than about 2000 mPa·s, preferably less than about 750 mPa·s, as measured at 20° C. (e.g., room temperature). In other embodiments, the viscosity of undiluted ionic liquids are in the range from about 0.1 to about 500 mPa·s, preferably from about 0.5 to about 400 mPa·s, and more preferably from about 1 to about 300 mPa·s at 20° C.

The viscosities of the ionic fluids and compositions containing them can be measured on a Brookfield viscometer model number LVDVII+ at 20° C., with spindle no. S31 at the appropriate speed to measure materials of different viscosities. Typically, the measurement is done at a speed of 12 rpm to measure products of viscosity greater than about 1000 mPa·s; 30 rpm to measure products with viscosities between about 500 mPa·s to about 1000 mPa·s; and 60 rpm to measure products with viscosities less than about 500 mPa·s. The undiluted state is prepared by storing the ionic liquids or cocktails in a desiccator containing a desiccant (e.g. calcium chloride) at room temperature for at least about 48 hours prior to the viscosity measurement. This equilibration period unifies the amount of innate water in the undiluted samples.

Advantageously, the ionic liquid active is in liquid form. Thus, the ionic liquid active is a means for providing highly concentrated functional actives that are conventionally only available in solid or paste form, or require large amounts of diluents or solvents to form liquids. In some embodiments, the need for other solvents and/or diluents can be significantly reduced. In specific embodiments, the ionic liquid active can form a liquid composition in “supercompact” form, i.e., containing no other solvent or diluent in addition to the ionic liquid, or in a “compact” form, containing only a minor portion of solvent or diluent in addition to the ionic liquid.

In one embodiment, the composition is a “supercompact” composition that is substantially non-aqueous, that is, the composition is substantially free of added water. As used herein, the term “added water” or “free water” refers to refers to the free, unbounded water that is intentionally added to the composition. The substantially non-aqueous compositions can contain less than about 10 weight percent, more specifically less than about 5 weight percent, even more specifically less than about 1 weight percent, added water. It is recognized that many ionic liquids are hygroscopic, thus, may contain appreciable amounts of water (referred to herein as the “innate” or “bound” water) ranging from about 0.01% to about 50%, preferably from about 0.1% to about 20%, by weight of the ionic liquid. It is recognized that once the composition is prepared, the water component (innate water or added water) can no longer be distinguished by its origin. Thus, the compositions of the present invention may comprise water, regardless of its origin, ranging from about 0.01% to about 50%, preferably from about 1% to about 40%, more preferably from about 5% to about 30%, even more preferably less than 10% by weight of the composition.

In additional embodiments, the “compact” compositions of the present invention contain a minor portion of water or other solvents, and the balance, ionic liquid actives. Such minor portion may be, for example, less than about 20%, alternatively, less than about 10%, further alternatively, less than about 5%, by weight of the composition.

The composition of the present invention has a viscosity less than about 5000 mPa·s. In another embodiments, the viscosity of such composition is less than about 2000 mPa·s at room temperature (about 20° C). In still another embodiment, the viscosity of such composition lowers to less than about 2000 mPa·s, preferably less than about 500 mPa·s, and more preferably less than about 300 mPa·s, when heated to a temperature in the range of about 40° C. to 60° C. In some embodiments, the compositions of the present invention have a melting point less than 100° C.

In a further embodiment, a composition according to the invention, comprising an ionic liquid active composed of a first ion active and an ionic liquid-forming counter ion, can be combined with another one or more additional ion actives to provide a liquid composition having additional treating benefits. The first ion active and the additional ion active(s) may be the same or different and may provide the same of different benefit properties.

The compositions may optionally include a solvent. Typical examples of solvents include, but are not limited to, linear or branched C1-C10 alcohols, diols, and mixtures thereof. In specific embodiments, solvents such as ethanol, isopropanol, propylene glycol are used in the compositions of the present invention.

In some embodiments, the composition is a clear liquid because any dispersed phase therein has a dimension less than the wavelength of visible light. In other embodiments, the clear compositions may comprise a homogeneous single phase in which the ionic liquid is dissolved or incorporated into a conventional aqueous phase, either in situ or with an optional surfactant added to the composition. Alternatively, the clear compositions may comprise a two phase liquid system in which the ionic liquids are dispersed in the conventional aqueous phase wherein ionic liquid droplets have a density and refractive index matched to the continuous phase. In further embodiments, the composition is a two phase liquid system having visibly separated aqueous phase and ionic liquid phase.

The compositions may comprise the ionic liquid active in any amount suitable for the desired functionality. In a specific embodiment, the compositions comprise the ionic liquid active in an amount of from about 1 to about 75 weight percent, more specifically from about 1 to about 40 weight percent, even more specifically from about 1 to about 20 weight percent of the compositions. Typically, the present compositions allow inclusion of greater amounts of active in a liquid form as compared with conventional compositions employing actives in conventional solid forms. Thus, in one specific embodiment, the composition may be in the form of a “supercompact” composition, comprising from about 50% to 100%, or from about 75% to about 99% of the ionic liquid active, the balance adjuncts and/or water. In an alternative embodiment, the composition is in the form of a concentrated or compact composition, comprising from about 50% to about 95%. Or form about 60% to about 80%, by weight of the ionic liquid active. In yet further embodiments, the compositions according to the present invention may comprise from about 1 to about 30 weight percent of the ionic liquid active.

The compositions of the present invention may be provided in various forms, including, but not limited to, hand dishwashing detergents, automatic dishwashing detergents, pretreating compositions, hand laundry detergents, automatic laundry detergents, and the like. The ionic liquid compositions may be formulated in the form of liquid, gel, paste, foam, or solid. When the composition is in the solid form, it can be further processed into granules, powders, tablets, or bars. The composition may be employed as a component of another cleaning product, for example by application to an absorbent substrate to provide a wipe for use in various applications. Any suitable absorbent substrate may be employed, including woven or nonwoven fibrous webs and/or foam webs. It is preferred that such an absorbent substrate should have sufficient wet strength to hold an effective amount of the multiphase composition according to the present invention to facilitate cleaning.

The invention therefore encompasses unit dose products, which typically employ a composition of the present invention in a unit dose package comprising a water soluble polymer film. Unit dose package such as those disclosed in U.S. Pat. No. 4,973,416; U.S. Pat. No. 6,451,750; U.S. Pat. No. 6,448,212; and U.S. 2003/0,054,966A1, are suitable for use with the composition of the present invention. The embodiments containing little or no water (e.g., the supercompact composition) may be advantageous for improving the stability of unit dose packaged materials and products.

The compositions according to the invention may additionally include one or more conventional fabric, surface and/or air treating adjunct components, as desired. Suitable adjunct components include, but are not limited to, additional detersive surfactants and builders (such as silica, zeolites, phosphates, polyacrylates, poly(acrylic-maeic) copolymers), enzymes, enzyme stabilizers (such as propylene glycol, boric acid and/or borax), suds suppressors, soil suspending agents, soil release agents, other fabric treating benefit agents such as anti-abrasion agents, wrinkle resistant agents, stain resistant agents, and water resistant agents, flame retardants, antimicrobial agents, metal bleach catalysts, bleach, fabric softeners, anti-pilling agents, water repellant agents, ultraviolet protection agents, pH adjusting agents, chelating agents, smectite clays, solvents, hydrotropes and phase stabilizers, structuring agents, dye fixative agents, dye transfer inhibiting agents, optical brighteners, sizings, perfumes, coloring agents, mixtures thereof, i.e., of two or more of these components, and the like. Additional examples of suitable components are disclosed in U.S. Pat. No. 6,488,943, Beerse et al.; U.S. Pat. No. 6,514,932, Hubesch et al; U.S. Pat. No. 6,548,470, Buzzaccarini et al.; U.S. Pat. No. 6,482,793, Gordon et al.; U.S. Pat. No. 5,545,350, Baker et al; U.S. Pat. No. 6,083,899, Baker et al; U.S. Pat. No. 6,156,722, Panandiker et al; U.S. Pat. No. 6,573,234, Sivik et al.; U.S. Pat. No. 6,525,012, Price et al.; U.S. Pat. No. 6,551,986, Littig et al; U.S. Pat. No. 6,566,323, Littig et al.; U.S. Pat. No. 6,090,767, Jackson et al.; and/or U.S. Pat. No. 6,420,326, Maile et al.

The various optional composition ingredients, if present in the compositions herein, should be utilized at concentrations conventionally employed to bring about their desired contribution to the composition. Frequently, the total amount of such optional composition ingredients can range from about 0.01% to about 50%, more preferably from about 1% to about 30%, by weight of the composition.

The compositions are easily diluted with water and/or organic solvent, without formation a gel phase during the dilution process. Within the present disclosure, the term “gel phase” is defined as a phase region in which the composition exhibits a significant increase (e.g., at least 10%) in viscosity upon dilution. Accordingly, the invention is further directed to processes for diluting compositions.

In one embodiment, the invention includes a process wherein a concentrate containing an active is mixed with an ionic liquid to form a product formulation. Optionally, a diluent (for example water or organic solvents), an adjunct, or combinations thereof that are commonly found in consumer product formulations and as disclosed herein are mixed in. As disclosed above, the presence of ionic liquid lowers the viscosity of the mixture and avoids the formation of the gel phase in the diluting process. This is advantageous for the processors because when the viscosity is lowered to from about 300 to about 5000 mPa·s, the composition can be processed in a typical high shear formulation system with ease. Additionally, since no gel phase is formed, the concentrate can be dispersed in the aqueous matrix more homogeneously and quickly. Moreover, because the low viscosity can be achieved at a relatively low processing temperature in the range of 20° C. to about 60° C., thus, there is little or no need to apply heat in the process, substantial savings in energy consumption can be achieved. The preparation of a consumer product from an active concentrate using conventional high shear mixing process is disclosed, for example, in U.S. Pat. No. 5,545,350.

In some embodiments, the ionic liquid used in the mixing step comprises an ion active; in other embodiments, the active concentrate is a supercompact composition containing ion active as disclosed above. Furthermore, the active or ion active of the concentrate and the ion active of the ionic liquid diluent may provide same or different benefit. For example, the active in the concentrate may be a fabric softener active and the ion active in the ionic liquid diluent may be a surfactant ion or a fabric softener ion.

In other embodiments, the ionic liquid used as diluent in the mixing step comprises ionic components are non-active or inert, that is, they do not deliver any desired benefits for cleaning, surface treating, air treating and/or fabric care benefit. Examples of such inert ionic liquids include but are not limited to the combination of cations such as pyrrolidinium, imidazolium, and the like, with anions such as methylsulfate, PF₆⁻, BF₄⁻, or halides.

In yet another embodiment, the process for diluting a composition to prepare a consumer product formulation comprises: a) providing a composition comprising a first ionic liquid comprising an ion active capable of delivering a fabric treating benefit, a surface treating benefit, and/or an air treating benefit, and b) diluting the composition by addition of water, organic solvent, and/or a second ionic liquid, wherein the composition does not exhibit a gel phase throughout the process. Furthermore, the first ionic liquid of the composition may be added to the composition prior to or simultaneous with the diluent water, solvent or second ionic liquid and undergoes the dissociation of ionic components, thereby forming additional ionic liquid active.

The avoidance of gel phase formation provides various benefits to the compositions of the invention. For example, concentrated or supercompact compositions containing ionic liquid active can be formulated into product formulations with ease as the lower viscosity of the ionic liquid supercompact or concentrate renders the compositions easy to pump in mixing processes. Thus, when the ionic liquid active is mixed with other components to form a consumer product formulation, the mixing step effects dispersion of ionic liquid active and/or other active materials and a significant initial increase in viscosity is avoided since no gel phase is formed.

The active concentrates typically contain from about 30 to about 98% or from about 60 to about 90%, by weight of the concentrate of the active material. The concentrates typically contain no more than 10% by weight of the concentrate of water and/or an organic solvent, such as lower alcohols. The concentrate may optionally comprise no more than 10% by weight of the concentrate of surfactants.

The resulting product formulation can contain from about 1% to about 30%, or about 5% to about 20%, by weight of the product composition of an active; from about 1% to about 60% by weight of the composition of an ionic liquid; and from about 30% to about 90% by weight of the composition of an diluent; and the balance of adjuncts. Moreover, in some embodiments, the diluent typically comprises water which is from about 30% to about 60% by weight of the product composition.

### EXAMPLE

In this example, a composition according to the invention is prepared. A fabric softener active comprising [DCEEDMA⁺][Cl⁻] of the formula: 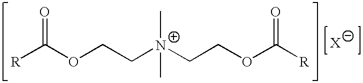
wherein R is canola and X is Cl, has a melting point of about 55° C. and a viscosity of about 8000 mPa·s at 70° C. and about 37,000 mPa·s at 55° C., which presents challenging formulation processing. According to the present invention, the chloride ion of the active is exchanged with 1,1,1-trifluoro-N-[(trifluoromethyl) sulfonyl] methanesulfonamidinate [NTf₂]⁻ to produce the compound [DCEEDMA] [NTf₂]. This compound is then added to ionic liquid comprising the pyrrolidinium salt [C₄MePyr][NTf₂] in a 9:1 weight ratio (0.954:0.046 molar ratio). The resulting mixture has a dramatically lower viscosity of about 250 mPa·s at 55° C. The viscosity increases slightly as the temperature is lowered but remains below 2000 mPa·s at room temperature.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for forming a product composition from an active concentrate, comprising
a) providing a concentrate containing a benefit agent capable of delivering a fabric treating benefit, a surface treating benefit and/or an air treating benefit; and
b) mixing the concentrate with an ionic liquid and optionally, a diluent, an adjunct, or combinations thereof, thereby forming the product composition;
wherein the product composition has a viscosity of less than about 5000 mPa·s at room temperature or less than about 2000 mPa·s at a temperature ranging from about 40° C. to about 60° C.

2. The process of claim 1, wherein the product composition has a viscosity of less than about 2000 mPa·s at room temperature.

3. The process of claim 1, wherein the product composition has a viscosity of less than about 300 mPa·s at room temperature.

4. The process of claim 1, wherein the composition exhibit no gel phase throughout the process.

5. The process of claim 1, wherein the benefit agent is selected from the group consisting of a fabric softener, a surfactant, a bleach, a bleach activator, an enzyme, a soil release polymer, an antimicrobial agent, a fabric softener, a dye, a dye fixative, an optical brightener, and combinations thereof.

6. The process of claim 1, wherein the ionic liquid is composed of an ion active and an ionic liquid-forming counter ion.

7. The process of claim 6, wherein the ion active of the ionic liquid and the benefit agent in the concentrate provide same or different benefit.

8. The process of claim 7, wherein the ion active is the ion form of an active selected from the group consisting of a surfactant, a bleach activator, an antimicrobial agent, a fabric softener, a dye, a dye fixative, an optical brightener, and combinations thereof.

9. The process of claim 6, wherein the ion active comprises at least one of a surfactant ion or a fabric softener ion.

10. A composition formed by mixing a concentrate containing a benefit agent with an ionic liquid and optionally, a diluent, an adjunct, or combinations thereof, thereby forming the product composition;
wherein the product composition has a viscosity of less than about 5000 mPa·s at room temperature or less than about 2000 mPa·s at a temperature ranging from about 40° C. to about 60° C.

11. The composition of claim 10, wherein the composition comprises from about 1% to about 30% by weight of the composition of a benefit agent; from about 1% to about 60% by weight of the composition of an ionic liquid; and from about 30% to about 90% by weight of the composition of an diluent; and the balance of adjuncts.

12. The composition of claim 10, wherein the diluent comprises water which comprises from about 30% to about 60% by weight of the composition.

13. The composition of claim 10, wherein the diluent comprises an ion active which contains a surfactant ion and/or a fabric softener ion.

14. A process for forming a product composition from an active concentrate, comprising
a) providing a concentrate containing a fabric softening active capable of delivering a fabric treating benefit; and
b) mixing the concentrate with an ionic liquid and optionally, a diluent, an adjunct, or combinations thereof, thereby forming the product composition;
wherein the process is conducted at a temperature in the range of from about 20° C. to about 60° C. and the product composition exhibits a viscosity of less than about 5000 mPa·s throughout the process.

15. The process of claim 14, wherein the fabric softening active selected from the group consisting of a dialkyl quaternary ammonium compound selected from the group consisting of N,N-ditallow N,N-dimethyl ammonium chloride (DTDMAC) and N,N-ditallowoylethanolester N,N-dimethylammonium chloride (DEEDMAC), triethanol amine ester methyl ammonium methylsulfate (TEEMAMS), and mixtures thereof.

16. The process of claim 14, wherein the benefit agent comprises from about 30% to about 98% by weight of the concentrate.

17. The process of claim 14, wherein the benefit agent comprises from about 1% to about 30% by weight of the product composition.

18. A process for preparing a product composition, comprising:
a) providing a composition comprising a first ionic liquid composed of an ion active and an ionic liquid-forming counter ion, the ion active is capable of delivering a fabric treating benefit, a surface treating benefit, and/or an air treating benefit; and
b) diluting the composition by addition of water, solvent, and/or a second ionic liquid;
wherein the composition does not exhibit a gel phase throughout the process.

19. The process of claim 18, wherein the ion active comprises in form of an active selected from the group consisting of a surfactant, a bleach activator, a bleach, an antimicrobial agent, a fabric softener, a dye, a dye fixative, an optical brightener, and combinations thereof.

20. The process of claim 18, wherein the first and the second ionic liquids contain same or different ion actives.

21. The process of claim 18, wherein the second ionic liquid does not contain an ion active capable of delivering a fabric treating benefit, a surface treating benefit, and/or an air treating benefit.
